(19) United States
(12) Patent Application Publication
(10) Pub. No.: US 2015/0102928 A1
(43) Pub. Date: Apr. 16, 2015

(54) REMOTE POWER STATE DETECTOR

(71) Applicant: Mikhail L. Sirotkin, Chagrin Falls, OH (US)

(72) Inventor: Mikhail L. Sirotkin, Chagrin Falls, OH (US)

(21) Appl. No.: 14/051,669

(22) Filed: Oct. 11, 2013

(51) Int. Cl. G08B 21/18; G08B 13/08

(52) U.S. Cl. CPC G08B 21/18; G08B 13/08
USPC 340/545.1; 340/635; 340/541

(57) ABSTRACT

A system for remotely detecting a power state of an associated device comprising: an optical sensor configured to detect a light emitted from the associated device, wherein the light is indicative of the power state of the associated device; or electrical field (EF) sensor to detect the electrical field around power cord of associated device, wherein the electrical field is indicative of the power state of the associated device; a transmitter in communication with the optical or EF sensor; the transmitter configured to transmit a notification responsive to the optical sensor detecting the light or to the EF sensor detecting the electrical field; a receiver configured to receive the notification; and an alarm in communication with the receiver, the alarm configured to generate a warning responsive to the receiver receiving the notification.

### CROSS-REFERENCE TO RELATED APPLICATIONS

The application claims the benefit of provisional patent application

Attorney Docket Number Sirotkin-optical ac-power

Customer Number 16393 filled 29 Oct. 2012 by the present inventor

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to the field of power consumption management and safety devices and in particular to devices that monitor the power status of appliances and electronic devices and alert the user of that power status. Leaving appliances energized can result in inadvertent waste of electricity, as well as fire and other safety hazards. For example, any appliance with a heating element, such as an iron, grill, hot plate, or space heater can cause substantial damage if left on in unsafe conditions.

One of the most common ways fires start in residential homes is when the occupant forgets to turn OFF the home appliances and leaves the building or goes to bed. The result of such carelessness is property damage and personal injury. There are several devices, which speak of this type of issue.

What follows is a brief review of the existing solutions for indicating the power state of home appliances (stove): some devices utilized an electrical current sensor detect an electrical state when that the stove is ON. (U.S. Pat. No. 5,608,378 Mc Lean) This current sensor requires adjustment and cannot be replaced from the stove to another appliance without additional readjustment of the minimal current level.

Another way to determine if the appliance is ON requires that the warning indicator should be electrically connected in parallel with the stove light. (U.S. Pat. No. 5,608,378 Mc Lean) When the stove light turns ON, the warning indicator, connected by wires to the stove indicator, will be activated too. This way also requires the rebuilding of the existing stove to connect additional wires.

Another way of power state indicator detects the position of the range knobs of the stove by using a magnetic reed switch, a button switch or optoelectronic switch. (US Patent 2006/0202848 Volodarsky) When the knob is in the ON position, the switch is activated and turns the warning device ON. This method also requires the adaptation of the existing appliances with the installation of additional switches.

Another several types of electrical cables with indicator lights described in U.S. Pat. No. 7,121,707 Robert M. Currie, U.S. Pat. No. 6,336,825 B1. Ronald Seefried. The indicator light is illuminated when the cord is connected to an electrical power source. But this light visible in distance a few feet only.

A useful device, therefore, would provide power monitoring for key appliances of concern and alert the user to the power status of those appliances, optionally providing a remote means of cutting the power as well.

This device would not need any readjustment or adaptation of the existing or new appliances and would provide flexible and easily configurable tool for home security system.

### SUMMARY OF THE INVENTION

Accordingly, the invention is directed to a system for monitoring the power status of appliances and alerting the user to the power status of an appliance that a user may wish not to be powered on. For each appliance of concern, a computer is provided with a sensing device. In one embodiment, an optical sensor may be placed over the appliance's power indicating LED, and in a second embodiment, a sensor may detect the electric field of the device's power cable. A software program running on the microprocessor detects power usage on designated appliances or outlets and wirelessly transmits an alert to an alert device located in a user determined location, or transmits an alert over the Internet or other data network to the user, for example in the form of an email or SMS message.

An apparatus for detecting a power state of an associated device comprising:

an detector (optical sensor configured to detect a light emitted from the associated device or a EF (electrical field) sensor to detect the electrical field around the AC power cord of the associated device) and a transmitter in communication with the detector, the transmitter configured to transmit a notification responsive to the detector:

wherein the light is indicative of the power state of the associated device and EF field is indicative of the power state of the associated device.

A method for detecting a power state of an associated device comprising:

detecting a light emitted from the associated device or detecting EF emitted from the power cord of the associated device, the light is indicative of the power state of the associated device and EF field is indicative of the power state of the associated device; and transmitting a notification responsive to the detector (optical sensor detecting the light or EF sensor detecting the electrical field).

A system for remotely indicating a power state of an associated device comprising:

an detector (optical sensor configured to detect a light emitted from the associated device or EF sensor to detect the electrical field emitted from power cord of associated device) wherein the light or EF fields are indicative of the power state of the associated device;

a transmitter in communication with the detector (optical sensor or EF sensor), the transmitter configured to transmit a notification responsive to the optical sensor detecting the light or to the EF sensor detecting the EF field;

a receiver configured to receive the notification; and an alarm in communication with the receiver, the alarm configured to generate a warning responsive to the receiver receiving the notification.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### DRAWINGS

FIG. 1 shows a diagram of the first exemplary embodiment.

FIG. 2 shows a diagram of the second exemplary embodiment.

FIG. 3 is a basic block diagram of a optical power state detector.

FIG. 4 is a basic block diagram of a power state detector with EF sensor.

FIG. 5 is a basic flow chart of process.

FIG. 6 is a stove with optical sensor assembly.

FIG. 7 is a iron with EF sensor attached to the power cord.

FIG. 8 is a warning system with two warning units.

FIG. 9 is a block diagram showing the optical sensor assembly.

FIG. 10 is a simplified schematic of the optical sensor assembly with photo transistor.

FIG. 11 is a block diagram of the warning unit and warning system.

### DETAILED DESCRIPTION OF THE PREFERRED EMBODIMENT

Referring now to the invention in more detail, the invention is directed to a system for monitoring the power status of an appliance or designated outlet and alerting the user thereto. The invention provides a system of electronic devices which may be physically located on or at an appliance or AC cord to be monitored, at a location where a user would like to receive and alert, or in a third location. Functional components, such as the computer's microprocessor and data storage, may be located anywhere, and may communicate over wired or wireless electronic channels with sensors located at the device or outlet to be monitored or with output devices located where the user would like to receive alerts. A single computer component may further communicate with multiple sensor devices and transmit data to multiple output devices. Alternatively, each monitoring device may be equipped with a self-contained computer component and monitoring device. Any combination of centralized or distributed architectures may thus be used in the invention.

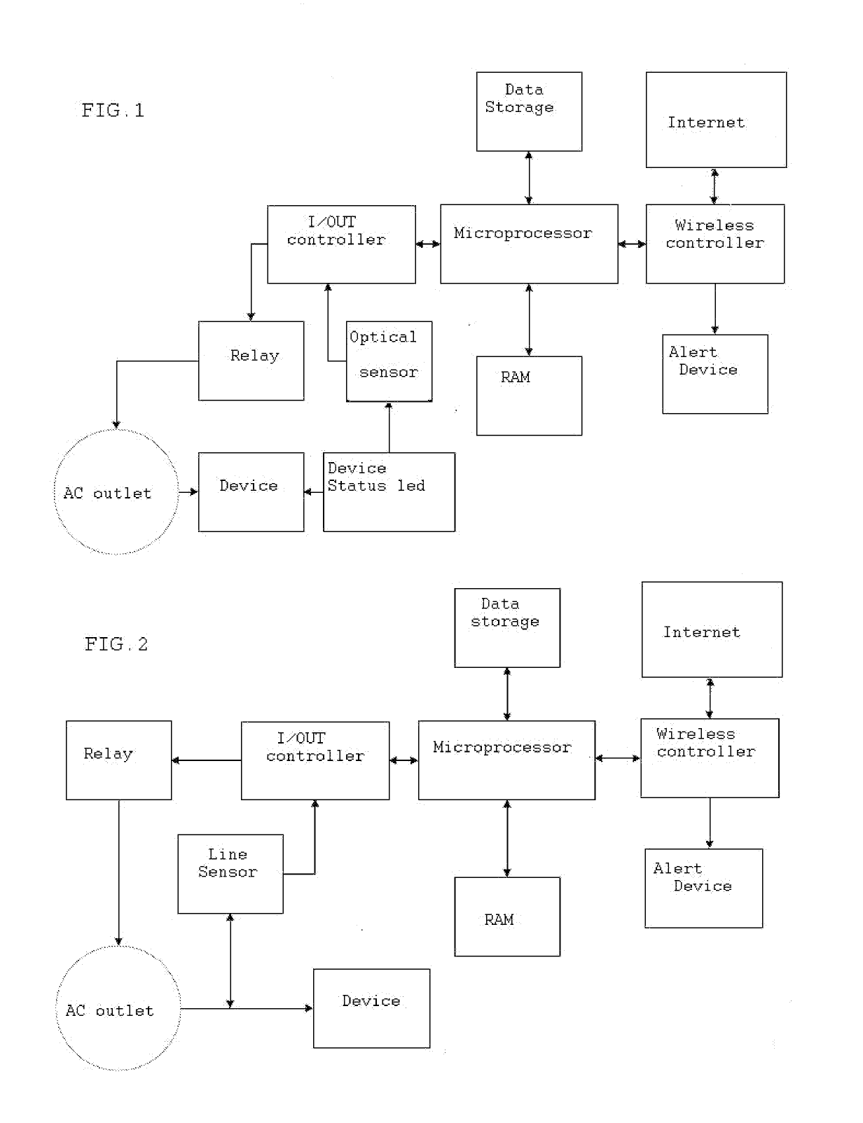

FIG. 1 shows a diagram of the first exemplary embodiment wherein an optical sensor is placed over the power status LED or other type of light of the appliance to be monitored. In the first exemplary embodiment, the optical sensor (which may be of any type of the several known in the prior art) is affixed, for example taped to the power status LED or other type of light of the device in question. An opaque backing may be applied to ensure that the only light detected by the optical sensor comes from the device power status LED. The optical sensor may further be specialized to detect a particular color of light or identify the color, for example to distinguish between on and off states shown by multi-color LEDs. The sensor transmits information wirelessly or over wires to an I/O controller which makes the data available to a microprocessor, which is equipped with RAM and persistent data storage. A wireless controller is provided which allows for communication with any number of alert devices placed at user-desired locations (for example near the exit door of a bedroom or other location where an iron or other dangerous appliance is used), and optionally with the internet or other data network, such as a mobile phone data network (wired network connections of course, may be substituted). An example of an alert device is a device having an illuminated sign reading, for example “Device Powered On”, where the user may optionally install a custom marquee identifying the particular device, or, for another example, a device having a speaker that produces a pre-recorded sound, such as a voice stating that a particular device is powered on. Optionally, the I/O controller may provide control signals to a relay which controls power flow to the outlet of the appliance to be monitored.

FIG. 2 shows the second exemplary embodiment. In the second exemplary embodiment, an AC line sensor detects an electric field surrounding the device's power cord. The other components are the same as those provided in the first exemplary embodiment. The two embodiments or other sensor types may be mixed and matched within the same system of device monitoring.

Referring now to both the first and second exemplary embodiments, stored on the data storage and executed by the microprocessor is a software program preferably having the following capabilities, all of which are well-known in the prior art: (1) detect power status by at one or more designated appliances or AC cords; (2) transmit power status information to one or more alert devices; (3) transmit power status notifications over a data network or the Internet to a data service or remote device, for example by sending an email message or SMS message; (4) optionally accept user input from an alert device or over a data network or the Internet indicating a requested shutoff of the monitored device; (5) respond to a user shutoff request by deactivating the associated relay and prohibiting power consumption by the monitored appliance or appliance cord; (6) accepting user program input designating particular devices or outlets, and particular output devices and data channels that should be grouped together or routed between for notification purposes; and (7) accepting user program input on the timing, frequency, content, and style of notifications. Optionally, a simpler embodiment may omit the microprocessor and associated components. Ordinary and simple digital logic circuitry of the kind well known in the prior art may be used to achieve one or more alert device activations based on the power status of the monitored appliance or appliance cord.

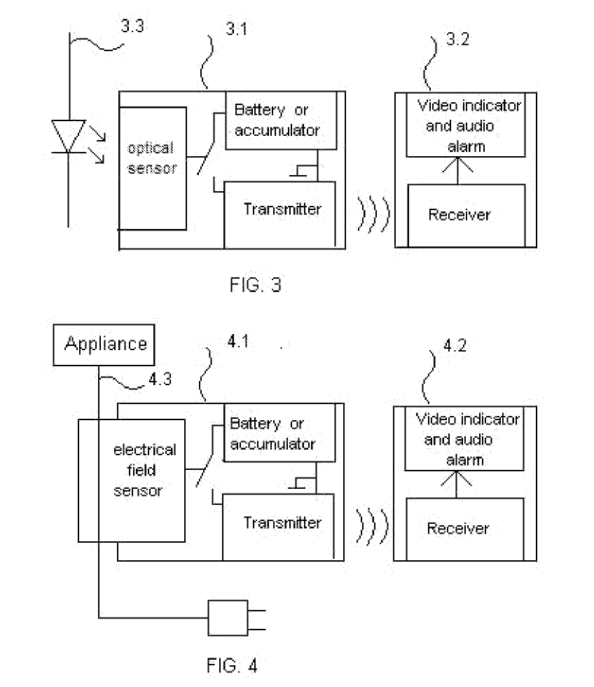

First referring to FIG. 3, which illustrates a basic block diagram of a remote power state detector, which includes an optical sensor assembly 3.1 and warning unit 3.2. The optical sensor assembly attached on the top of the power state LED (light-emitting diode) 3.3 of the appliance. The power state LED has two states and emits light when appliance is ON and does not—if OFF.

Optical sensor assembly comprises an optical sensor, battery (or accumulator) and radio frequency (RF) transmitter. The warning unit 2 comprises a RF receiver, battery or accumulator (not shown) and video and audio alarm device.

When the optical sensor assembly detects the lights from a LED of the appliance, it activates the transmitter and transmitter emits the RF signal. The receiver of the warning unit detects this RF signal and turns ON visual indicator and activates (in certain condition) audio alarm.

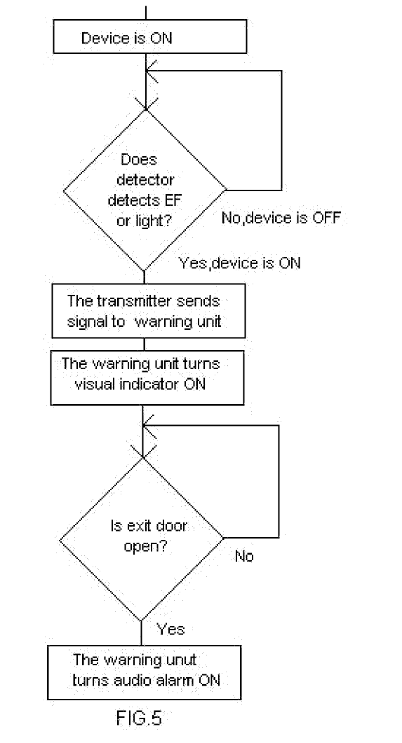

FIG. 4 illustrates a basic block diagram of a remote power state detector with EF sensor assembly which includes an EF sensor assembly 4.1 and warning unit 4.2. When the EF sensor assembly detects the electrical field around the power cord of appliance it activates the transmitter and transmitter emits the RF signal. The receiver of the warning unit detects this RF signal and turns ON visual indicator and activates (in certain condition) audio alarm. The warning unit (units) can be installed near the exit door to prevent property damage if occupant forgets to turn OFF the appliance and leaves the building.

FIG. 5 illustrates a basic block diagram of process.

If device is ON, the optical sensor detects the light emitted from the LED of device or EF sensor detects the electrical field around the power cord. If the signal from optical or EF sensor detected, the sensor activates the transmitter and transmitter sends the signal to the warning unit. The warning unit turns ON the visual indicator and detects if the exit door is open or closed. If the exit door is open, the warning unit also turns ON the audio alarm.

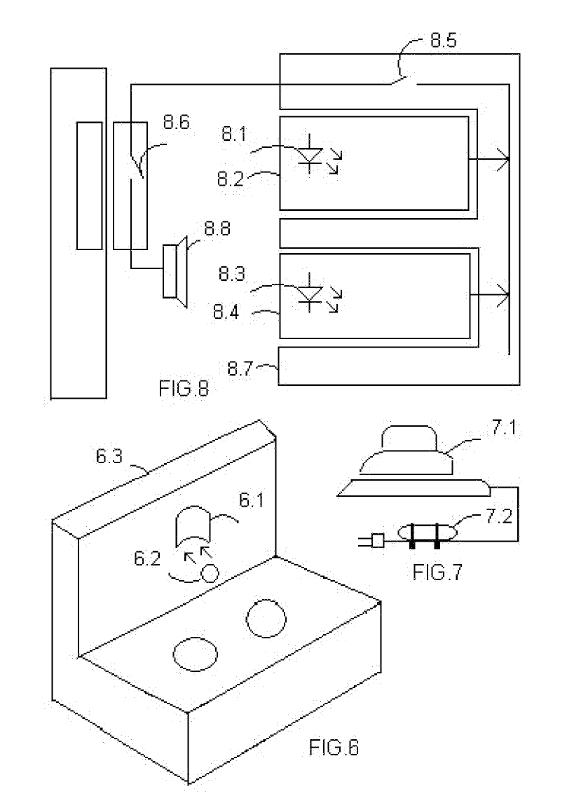

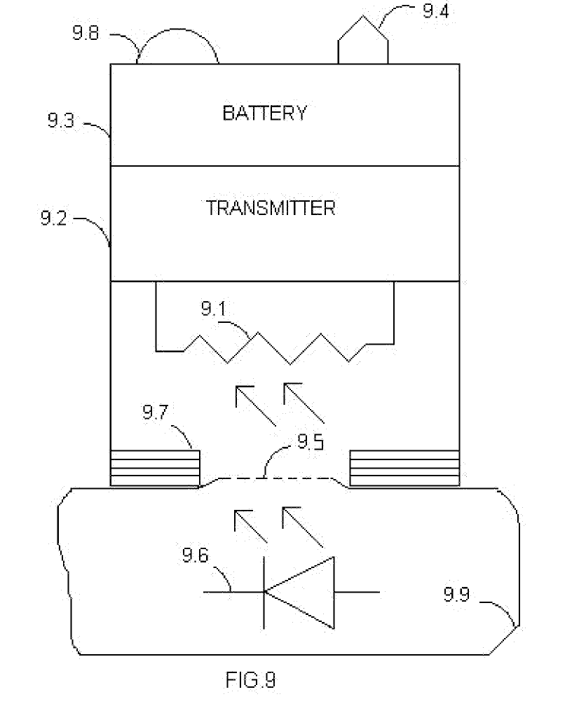

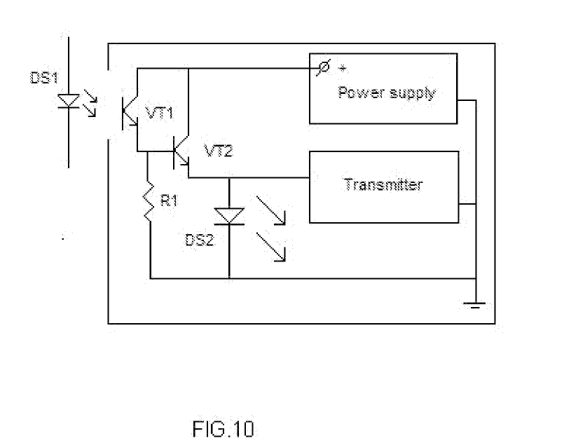

Referring to FIG. 6, the remote power status indicator includes an optical sensor assembly 6.1 attached to the top of the power ON/OFF LED indicator 6.2 located on the front panel of stove 6.3 or any appliances with power ON/OFF light indicator. The optical sensor assembly 6.2 is comprised of a photo sensor and RF transmitter. All stoves include an LED indicator on their instrument panel that indicates if one or more burner is on. When any heating element of the stove is turned ON, a photo sensor detects a light from the LED indicator 6.2 and issues the corresponding electrical signal to activate the transmitter. The transmitter sends a radio frequency (RF) signal to corresponding warning unit 8.2 The warning unit turns ON LED 8.1 or any suitable lighting device. Also, the warning unit closes switch 8.5 (in series with door switch 8.6), which activates audio alarm 8.8, if the door is open. Warning system 8.7 can hold one or more warning units. Any activated warning unit closes switch 8.5 to turn on the audio alarm. The warning unit can be easily installed in the warning system or removed and carried by an individual. Optical sensor assembly 6.1 has adhesive tape on the bottom. This allows the device to be easily detached from, for example, the stove and reattached to an iron or any appliance with a power LED ON-OFF indicator, even a gas stove (modern gas stoves have power status LED indicator). This makes the system very flexible and easy to configure for a variety of appliances.

FIG. 7 shows the iron 7.1 with EF sensor 7.2, attached to the power cord of iron with tie wrap or clips. If EF has detected, the EF sensor activates the warning unit 8.4, installed in warning system 8.7. The warning unit turns ON LED 8.3 or any suitable lighting device. Also, the warning unit closes switch 8.5 (in series with door switch 8.6), which activates audio alarm 8.8, if the door is open.

The owner can take out the optical sensor or EF sensor and attach it to another appliance at any time he needs it. RF frequencies are different for every pair of transmitters and receivers (frequency coding) to eliminate the interferential signal.

Illustrated in FIG. 9, the optical sensor assembly is comprised of photosensitive device 9.1 (photoresistor, photodiode, phototransistor) and transmitter 9.2 powered by a battery or accumulator 9.3. This unit can also use connector 9.4 to connect to the A/C adapter, if it is powered by the house current. The optical sensor assembly has window 9.5 to provide an optical link between photo sensor 9.1 and LED 9.6 of appliance 9.9. Also, the optical sensor assembly has adhesive tape or fastening tape 9.7, and can be easily removed or attached to the top of the power LED ON/OFF indicator located on the front panel of another appliance. With modern electronic technology, an electronic device, similar to an optical sensor assembly, can be built so that it is small enough to place this device above the LED indicator of any appliance.

When the appliance 9.9 is ON or is in an active condition (for instance one or more heating elements are turned ON in the stove) the photo sensor detects light from the LED and activates transmitter 9.2. The warning unit receives an RF signal from the transmitter and turns ON the visual alarm.

To reduce power consumption of the optical sensor assembly, the transmitter would send the short RF signal periodically (for instance 1 pulls per 1-2 sec) and the warning unit can hold an active condition over that time. Also the optical sensor assembly would have its own LED 9.8. When the photosensor detects the light from the LED of an appliance, it turns the LED 9.8 ON to provide a visual indication of the power state of appliance. This LED can be brighter than the LED of the appliance, making it more visible. That is, the warning unit can be a substitute for the small LED of the appliance for people with poor eyesight. In this case, the optical sensor assembly works as an amplifier of the light.

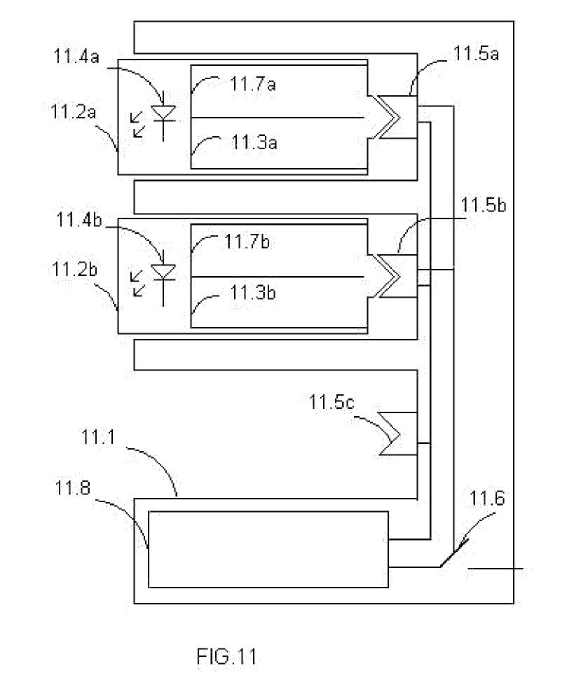

Simplified schematic of the optical sensor assembly with phototransistor illustrated on the FIG. 10. The optical sensor assembly comprises power supply (battery or accumulator) transmitter, phototransistors VT1, transistor VT2, resistor R1 and LEDs DS1 and DS2. The LED of appliance (DS1) triggers the phototransistor VT1 into conductive state. The output of the phototransistor applied to the base of the transistor VT2. The transistor VT2 turns ON, connects the transmitter to power supply and activates the DS2. The resistor R1 stabilized the transistor VT2 when it OFF. The power switch VT2 can be controlled by another photosensitive device (photo resistor, photodiode) with the corresponding schematic.

As shown in FIG. 11, warning system 11.1 is a base for one or more warning units 11.2a and 11.2b. Each warning unit has an RF receiver 11.3a, 11.3b. When any optical sensor assembly detects a change in the electrical state of the appliance (from OFF to ON), the corresponding receiver detects the input RF signal, activates LED 11.4a, 11.4b, and sends through connector 11.5a, 11.5b a command to close switch 11.6, which is connected in series with door switch 8.6 FIG. 6, to turn the audio alert ON. Also, connector 11.5a, 11.5b, 11.5c is used to connect every warning unit to power supply 11.8, in order to charge accumulator 11.7a, 11.7b. Every warning unit has a delay mechanism to prevent a false report that the stove or heater is in the OFF state, when the heating element is only temporary turned OFF.

To distinguish between each pair, the optical sensor assembly and warning unit can be the same color (green-green, blue-blue . . . . )

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

Advantages

From the description above a number of advantages of some embodiments of the remote power state detector become evident:

a. the remote power state detector with an optical sensor would be a universal and reliable mechanism to control the power state of appliances with power LED ON-OFF status indicators.

b. the remote power state detector with an EF sensor would be a universal and reliable mechanism to control the power state of appliances without power switch (like iron or grill)

c. the remote power state detector with optical or EF sensor is easily configurable and provides a very flexible tool for home security systems.

d. the remote power state detector does not need any adjustments to detect the power status of different appliances.

e. the optical and EF sensor assembly can be easy installed without any adaptation of existing or new appliances.

f. the optical sensor assembly can provide a more vivid LED ON/OFF indicator than the LED of appliances (Amplifier of light). This feature is very helpful for people with poor eyesight.

Although the description above contains many specificities, the remote power state indicator can be developed with an alternative design of the optical sensor unit, such as a unit with a fiber optical cable.

What is claim is:

1. An apparatus for detecting a power state of an associated device comprising:
an detector (optical sensor configured to detect a light emitted from the associated device or a EF sensor to detect the electrical field (EF) around the AC power cord of the associated device) and a transmitter in communication with the detector, the transmitter configured to transmit a notification responsive to the detector:
wherein the light is indicative of the power state of the associated device and EF field is indicative of the power state of the associated device.

2. The apparatus of claim 1, wherein the optical sensor is configured to detect light emitted from an LED associated with an appliance or EF sensor, configured to detect the electrical field emitted from the power cord associated with an appliance.

3. The apparatus of claim 1, wherein the transmitter is configured to transmit the notification using radio frequency.

4. The apparatus of claim 1, further comprising an adhesive element configured to affix the apparatus to the associated device.

5. The apparatus of claim 1, wherein the apparatus is portable.

6. The apparatus of claim 1, further comprising an LED, wherein the LED is configured to emit a second light responsive to the optical sensor detecting the light emitted from the associated device.

7. A method for detecting a power state of an associated device comprising:
detecting a light emitted from the associated device, the light indicative of the power state of the associated device and transmitting a notification responsive to the optical sensor detecting the light or detecting a EF emitted from the power cord of associated device, the EF field indicative of the power state of the associated device and transmitting a notification responsive to the EF sensor detecting the electrical field.

8. The method of claim 7, further comprising transmitting the notification using radio frequency.

9. The method of claim 7, further comprising emitting a second light responsive to the optical sensor detecting the light emitted from the associated device.

10. The method of claim 7, further comprising:
receiving the notification at a remote device; and
activating a visual indicator at the remote device responsive to receiving the notification.

11. The method of claim 10, further comprising activating a visual indicator at the remote device responsive to receiving the notification.

12. The method of claim 10, further comprising activating an audible indicator at the remote device responsive to detecting an associated door is in an open state.

13. A system for remotely detecting a power state of an associated device comprising:
an optical sensor configured to detect a light emitted from the associated device, wherein the light is indicative of the power state of the associated device;
or electrical field (EF)sensor to detect the electrical field around power cord of associated device,wherein the electrical field is indicative of the power state of the associated device;
a transmitter in communication with the optical or EF sensor, the transmitter configured to transmit a notification responsive to the optical sensor detecting the light or to the EF sensor detecting the electrical field;
a receiver configured to receive the notification; and an alarm in communication with the receiver, the alarm configured to generate a warning responsive to the receiver receiving the notification.

14. The system of claim 13, wherein the optical sensor is configured to detect
light emitted from an LED associated with an appliance.

15. The system of claim 13, wherein the transmitter is configured to transmit the notification using radio frequency.

16. The system of claim 13, further comprising an LED, wherein the LED is configured to emit a second light responsive to the optical sensor detecting the light emitted from the associated device.

17. The system of claim 13, wherein the alarm is configured to generate a visual warning.

18. The system of claim 13, wherein the alarm is configured to communicate a second notification to an associated home security system responsive to the receiver receiving the notification.

19. The system of claim 13, further comprising a door switch in communication with the alarm:
wherein the door switch is configured to determine the state of an associate door; and wherein the alarm is configured to generate an audible warning responsive to the door switch detecting the associated door in an open state.

20. The system of claim 13, further comprising a plurality of receivers configured to receive a plurality of notifications.
